(19) United States
(12) Patent Application Publication
(10) Pub. No.: US 2018/0084781 A1
(43) Pub. Date: Mar. 29, 2018

(54) SOLID-ADSORBED UREAS

(71) Applicant: M J W Outdoor Group, Evans City, PA (US)

(72) Inventor: Mark Weiser, Evans City, PA (US)

(73) Assignee: M J W Outdoor Group, Evans City, PA (US)

(21) Appl. No.: 15/480,935

(22) Filed: Apr. 6, 2017

Related U.S. Application Data
(60) Provisional application No. 62/319,418, filed on Apr. 7, 2016.

(51) Int. Cl. A01N 47/28; A01N 25/08

(52) U.S. Cl. CPC A01N 47/28; A01N 25/08

(57) ABSTRACT

The present invention is an admixture combining a (preferably natural) animal urine or urea source with an adsorbing base, solid or particulate carrier, which carrier includes at least one mineral, at least one botanical, or both. By combining the urea from the urine with at least one botanical and/or at least one mineral, followed by a critical step of drying the material to adsorb the urea to the carrier, the present composition remains potent to deploy a surprisingly improved urea scent upon moistening and deployment of the composition in the environment. When a botanical is present, moreover, the adsorbed urea has the chemical activity or potentiating compounds within the botanical, such as sulfur compounds in garlic.

### CROSS REFERENCE TO RELATED APPLICATION

This patent application claims priority to, and incorporates herein by reference, U.S. Provisional Patent Application No. 62/319,418 filed 7 Apr. 2016.

### FIELD OF THE INVENTION

The invention pertains to solid-phase urea adsorbents for use in animal, fish and insect attractant and repellent compositions.

### BACKGROUND OF THE INVENTION

Heretofore it has been known to use animal urine in a myriad of forestry, animal husbandry and property protection operations. Cow urine has been used, in aqueous dilution, as a crop spray to combat bacteria, viruses and fungus. On the other hand, urine is a well known constituent of both animal repellents and animal attractants, depending on the type of urine used and the animals intended to be attracted or repelled. As a general rule, the urine of carnivorous animals will ubiquitously repel any wild animal, if presented in a way that the wild animal desired to be repelled can detect it. By contrast, deer urine—especially in combination with deer gland extracts and plant extracts—will attract deer, as a hunting lure. Patented examples of animal scents include urine are taught, for instance, in U.S. Pat. No. 4,944,940 to Christenson, II, in U.S. Pat. No. 5,672,342 to Bell and in U.S. Pat. No. 6,149,9014 to Weiser. Christenson, II discloses animal scents wherein urine from a number of different animals are blended together, and Bell teaches a method of making an animal scent kit with urine from a single animal. Weiser teachers animal scent (urine) mixed with calcium carbonate, although in amounts low enough to keep the calcium carbonate powder “from clumping” due to the moisture.

Challenges in the commercial capture and deployment of urine and urea have been widespread, however. An admixture of urine with calcium carbonate that is sealed immediately after compounding will, without more, have such a diluted urine component that, after any sort of exposure to the environment, the urine will simply deteriorate and dissipate, destroying any benefit of its initial presence. Various commercial urine-containing compositions also undergo inadvertent damage to the urine component during antimicrobial bleaching or pasteurization. Failure to conduct antimicrobial processing steps, however, can foster bacteria or pathogen contamination in commercial liquid urine products. A need remained in the prior art, therefore, for a urea-containing attractant or repellant technology which could overcome the deterioration or contamination endemic with prior art products and methods and also provide new and unexpectedly improved results in urea-based animal, fish and insect scent products.

### SUMMARY OF THE INVENTION

In order to meet this need, the present invention is an admixture combining a natural animal urine or urea source with an adsorbing base, solid or particulate, which base optionally includes a botanical, or which base is a botanical. By combining the urea from the urine with at least solid to which the urea component of the urine can adsorb, the urea can be stabilized in its adsorbed condition when the solid base is carefully dried. Also, when a botanical is present, the urea adsorbed to the botanical potentiates one or more compounds found in the botanical, to render the resulting animal, fish or insect attractant or repellent significantly more potent than if the urea were present by itself on a solid or particulate carrier. For example, when the present admixture includes calcium carbonate, garlic and animal urine, during admixing and gentle drying the urea in the urine not only adsorbs to the garlic but potentiates the sulfur-containing compounds in the garlic, to create a stronger and longer-lasting scent. While the ability of various botanicals to attract or to repel various wild game, rodents, fish, insects and etc. is well known at this writing, as well as the general uses of urine as both an attractant and a repellant, many challenges in the prior art are overcome by the combination of animal urine with at least one solid carrier, importantly followed by gentle drying to adsorb the urea to the carrier with evaporation of other components and liquids in the urine, and with optional potentiation of at least one botanical and its constitutents, when a botanical is present. By drying and stabilizing the urea adsorbed to the carrier, it then becomes possible to reactivate the material, at the time of use, by rehydrating it or by applying a choice of liquids to redeploy the scent of the urea captured in the material by the present method.

### DETAILED DESCRIPTION OF THE INVENTION

The present invention admixes urea, preferably concentrated from natural animal urine, with a base carrier that optionally includes at least one botanical. In some cases, the base carrier IS the botanical, or a mixture of botanicals, but the base can alternatively be a mineral including without limitation calcium carbonate, vermiculite, limestone, ground stone or corn cobs, fullers earth, diatomaceous earth or other inert or quasi-inert materials suitable for exposure to or distribution within game preserves, public and private land, forests or developed property. Botanicals include without limitation garlic, onion, clove, cinnamon, white pepper, black pepper, rosemary, thyme, peppermint, oregano, anise, and cayenne pepper. Typically, the present botanicals are aromatic botanicals. While the base to which the urea adsorbs may be any solid, ordinarily the present invention is urea adsorbed to particulate base mineral or botanical carrier materials. Particulate material is versatile, in that it may be placed along property lines or in desired locations all by itself, or deployed in perforate or vapor permeable containers with or without surrounding housings. The key to the present invention is the surprisingly new and improved scent generation result that occurs when urea is adsorbed to a base carrier (mineral or botanical) followed by drying so gentle that none of the urea or other constituents is denatured by the heat of drying, further followed by rehydration or liquid activation of the composition containing the adsorbed urea, at the time of use.

While it is possible to make the present admixture with urea already purified from any natural or synthetic source, preferably the present compositions are made from animal urine that is collected fresh, as part of the manufacturing process. Urine collection for the purpose of manufacturing animal scents is already well known at this writing, and urine can be collected from a wide variety of animals for use in the present invention, such as coyote, fox, deer, elk, moose, bear, rabbit, fish, and sheep, without limitation. After urine is collected, and without pasteurizing it or otherwise antimicrobially treating it, the urine is admixed with the desired carrier material. For example, after collecting coyote urine it may be admixed with ground corn cobs, and co-minuted garlic heads and stems, together with vermiculate—as just one of many examples. The ratio of animal urine to solid material may vary greatly, but the preferred ratio is about 20 parts by weight of solid carrier material to 1 part by weight liquid urine, more or less. The admixed materials are then dried, at ambient temperature or at a maximum heat of about 140 degrees F., to prevent any denaturing that might occur with significantly higher heats. Drying times vary, especially at lower or ambient temperatures, but generally the admixture will dry within a 24 hour drying period, as a general rule. Mixing can continue throughout the drying process, or the solid or particulate matter may be laid out in a drying bed or other arrangement known in the art.

A typical rodent repellent is formulated with coyote urine combined with seven botanicals selected from the group consisting of onion, oregano, garlic, clove, cinnamon, white pepper, black pepper, rosemary, thyme, peppermint, anise or cayenne pepper, together with vermiculite or perlite. By mixing 20 parts by weight of solid materials with 1 part by weight coyote urine, which is itself about 4-5% urea, the ultimate urea content of the dried admixture will be about 80 parts by weight solid material to 4 parts by weight urea after the admixture is dried. However, as discussed above, the adsorption of the urea onto compounds and compositions within the botanicals—particular to sulfur-containing compositions in the botanicals—enhances the scent and smell significantly as contrasted to the scent effect of 4 parts urea within 80 parts of carrier, considered alone. However, this enhancement remains latent until the combined and dried materials are partially or completely rehydrated at the time of use, when the enhanced odors formed by the present composition are unmistakeable. As simple a testing device as a human nose can discern the surprising and dramatic increase in scent, as compared to when no botanical is present in the carrier. Particle size is relatively unimportant to the present invention, which can also be a solid, but generally particle size distributions when particles are present will range in the area of between about 0.03 mm to 0.75 cm.

Sometimes urine is included in an attractant composition as well. A fish attractant can be made which includes animal urine, garlic, white pepper, cayenne pepper and calcium carbonate, together with an oil component and the resulting fish attractant is significantly potentiated compared to fish attractants that contain the same botanicals but do not contain the urea. Deer attractants can be made with deer urine, deer gland extracts and herbs already known to be attractant agents as to deer populations. The present invention does not purport to be the first combination of materials known to attract fish, deer, insects, other animals, etc.—but the present composition is the first to result from the insight that combining urea-containing materials with a solid carrier AND THEN gently drying the carrier, to adsorb the urea in a stable form right until the material is rehydrated or activated for deployment, gives new and unexpectedly improved results in both the attractant and repellant technologies that rely on the scent properties of urea as an enhancing agent. Similarly, repellents for insects can be made the same way—urine and botanical insect repellants are already known, but it has not been known heretofore to stabilize the urea component of an insect attractant or repellant by adsorbing the urea to a solid carrier (mineral or botanical) and then dehydrating the carrier for shelf stability prior to deployment of the composition.

Although the invention has been described completely above, the following examples are illustrative.

### EXAMPLE 1

To 3 lbs of calcium carbonate granules and 1 pound of particulate fullers earth were added one quarter pound (about a quarter pint) of collected liquid coyote urine, in a vessel with mixing. After thorough admixing at ambient temperature, about 2 1/1 ounces each of garlic, onion, clove, cinnamon, white pepper, rosemary and oregano were stirred into the admixture, in an automatic stirring vessel. The stirring speed was then lowered to the lowest setting (about 15 rpm) and the container contents were allowed to dry at ambient temperature for 18 hours. At the end of 18 hours, a dry, aromatic particulate composition remained. The composition of this example has application to property perimeters or any other location where rodent or other wild animal repellent action is needed, and should be moistened before use with water or any other desired liquid (which can include, when available, additional animal urine). The ingredients are safe for the environment, and nontoxic to adults and children, but effectively repels rodents or any other wild animals for about one month after activation (moistening) and placement. The composition should be replenished once every month. (As a matter of practicality, this example may be alternatively practiced with urine from any carnivorous animal. Deer urine, coming from an herbivore by definition, is not as reliable a repellant for wild animals generally, and can indeed be a useful constituent of an attractant composition for deer, for obvious reasons.)

### EXAMPLE 2

Example 1 was repeated without addition of any botanicals. The urea component was calculably greater in the end product, although no potentiation of compounds found in the botanicals occurred as a result of the adsorption of urea. Still, due to the dessication prior to moistening at the time of composition deployment, the composition still functioned effectively to repel wild animals including deer and rodents.

### EXAMPLE 3

A fish attractant was made by combining 27 ounces of herring oil, 2 ounces each of comminuted garlic (heads, leaves and stalks), anise and cayenne pepper, and about 3 ounces of coyote urine, together with about 47 pounds by weight of calcium carbonate. Admixing and drying was performed according to Example 1. As with Example 1, it was not necessary to seal the admixture to prevent contamination, because the present admixtures are naturally antimicrobial due to the botanicals present and also inert due to the dehydrating of the admixture that occurs during the process.

### EXAMPLE 4

Example 1 was repeated but with 50 pounds calcium carbonate, 30 ounces liquid coyote urine, and 2 ounces each of garlic, onion and clove, prior to processing according to the remainder of the description in Example 1.

### EXAMPLE 5

An insect repellant is compounded by admixing all of the ingredients of Example 1 and drying them as described. However, a final step is added to comminute the dried admixed ingredients to a fine powder. The powder is kept in a dry condition until ready for use, and then the powder can be used by sprinkling it in and around the soil, stalks and leaves of plants for which insect repellency is desired, and can also be suspended in water used to hydrate or to treat plants, leaves and the surrounding soil. The same powder may also be included in formulations such as soaps, candles, air fresheners, sprays and mists, so that the powders when reactivated by moistening exert their insect repellant effect in the relevant area. Hand and body soaps containing this powder activate upon use to create an insect repellant that does have a detectable, but not unpleasant, smell to humans—and which is extremely effective as an insect repellant, especially as to mosquitoes. For travelers to malaria-plagued countries such as Nigeria, Kenya and many others, a mild botanical insect repellant smell, in an otherwise non-toxic insect repellant hand and body soap, is a small price to pay. Without a nontoxic antimalarial moquito repellent such as the present powder, the unfortunate Caucasian traveller to these regions is often left with the impossible choice between malaria itself, which is a terrible and long-lasting disease, and the often hallucinogenic drugs typically prescribed as antimalarials, in Western medicine. The present insect repellant compositions remove the dilemma of such a difficult choice, and provide instead a delightful, natural way to keep insects at bay.

Although the invention has been described with particularity above, the invention is only to be limited insofar as is set forth in the accompanying claims.

I claim:

1. An environmentally friendly urea composition comprising at least one solid carrier having adsorbed thereto a urea component from animal urine, said urea and said carrier having been dried without denaturing, said composition being ideal for moistening prior to use as an attractant or repellant.

2. The composition according to claim 1, wherein said at least one solid carrier includes a botanical, and wherein said botanical is selected from the group consisting of onion, garlic, oregano, cinnamon, white pepper, black pepper, rosemary, thyme, peppermint, anise and cayenne pepper.

3. The composition according to claim 1, wherein said at least one solid carrier includes a mineral or mineral-like substitute, wherein said mineral or mineral-like substitute is selected from the group consisting of calcium carbonate, vermiculite, perlite, fullers earth, diatomaceous earth, ground corn cobs, ground sea shells and ground stone.

4. The composition according to claim 1, wherein the concentration of adsorbed urea is about 4 parts by weight urea to about 80 parts by weight of carrier material.

5. The composition according to claim 2, wherein two or more botanicals are present in said carrier.

6. The composition according to claim 2, wherein seven or more botanicals are present in said carrier.

7. The composition according to claim 1, wherein said composition contains urea obtained from one or more carnivorous animals and wherein said composition is a repellant to all sorts of wild animals including but not limited to deer and rodents.

8. The composition according to claim 2, wherein said composition is an attractant to fish.

9. The composition according to claim 1, wherein said composition is a repellant to insects.

10. The composition according to claim 6, wherein said urea is derived from deer urine and wherein deer gland extracts are also present, to make a composition able to attract deer upon moistening and environmental placement thereof.
